(19) United States
(12) Patent Application Publication
(10) Pub. No.: US 2003/0134553 A1
(43) Pub. Date: Jul. 17, 2003

(54) Sound absorbing article

(75) Inventor: Arie Sheffer, Kfar Sirkin (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: L.S.I. (420) Import Export And Marketing Ltd.

(21) Appl. No.: 10/043,336

(22) Filed: Jan. 14, 2002

(51) Int. Cl. B32B 5/02; B32B 27/04; B32B 27/12; B32B 3/28; B32B 3/30; B32B 3/26

(52) U.S. Cl. 442/120; 442/394; 442/136; 428/304.4

(57) ABSTRACT

A sound absorbing article, which may be formed to a thickness of between 1 and 2 mm and have an NRC value between 0.8 and 0.85, is provided. Additionally the sound absorbing article may be formed of materials, which are flame retardant and environmentally friendly. The sound absorbing article includes (i) a material which is pervious to air, and which is characterized by proximal and distal surfaces with respect to a sound source, an internal structure, and a specific weight; (ii) a coating which adheres to the surfaces and internal structure, thus increasing the specific weight by a predetermined factor; and preferably (iii) a membrane, attached to the material at selected bonding points, forming interconnected channels between the material and the membrane, and allowing air to pass through them.

### FIELD OF THE INVENTION

The present invention relates to a sound absorbing article.

### BACKGROUND OF THE INVENTION

Sound reverberation in closed spaces, such as classrooms, offices, living areas, and cars is a significant contributor to background noise. Studies in acoustics and speech intelligibility have shown that as reverberation is reduced, speech intelligibility improves. Thus, controlling reverberant sound is important not only for comfort, but also for improved communication in schools, workplaces, homes and automobiles.

Sound reverberation is controlled by incorporating sound absorbers to the interior design of the closed space. The sound absorbers may be acoustic wall panels, ceiling panels, office partitions, rug liners, automotive hood liners and door liners, or liners for air-conditioning systems.

There are several methods for evaluating the sound-absorbing characteristics of a sound absorber. Their descriptions may be found, for example, in the web site, “Summary of Acoustic Testing Methods,” Aero-Acoustics Laboratory, www.industrialacoustics.com/RDMETH.htm. A specific example is ASTM C423, “Sound Absorption and Sound Absorption Coefficient, by the reverberation Room Method,” leading to measured values of sound absorbing coefficients at different sound frequencies.

A sabin is a unit of sound absorption. Sabin absorption is defined as the sum of absorption due to objects and surfaces in a room, and due to dissipation of energy in the medium within the room. In a reverberation chamber of volume V, speed of sound c, and reverberation decay rate d, sabin absorption is computed as A=0.921 Vd/c in metric units.

The sound absorption of a given material is computed as the difference in sabin absorption, for each frequency band, with and without the material under test present in the reverberation chamber. The sound absorption coefficient for the given material is its sound absorption, for each frequency band, divided by the surface area of the given material.

In general, sound absorbers are evaluated by an overall parameter, a Noise Reduction Coefficient (NRC), which is an arithmetic average of the sound absorption coefficients at 250, 500, 1000, and 2000 Hz. However, for some applications, absorption of a characteristic noise, for example, the noise of a helicopter rotor, requires absorption at a specific range of frequencies, for example, the low range. The sound absorbers are then evaluated at the specific range of frequencies for the application.

“Modeling of Horns and Enclosures for Loudspeakers,” by Gavin R. Putland, Department of Electrical and Computer Engineering, University of Queensland, described in http://www.users.bigpond.com/putland/phd/thes.pdf, provides a detailed analogy between an acoustic circuit and an electrical circuit. Accordingly, the sound absorption characteristics of a material are described as acoustic impedance, a complex quantity consisting of frequency dependent components called acoustic resistance and acoustic reactance.

ASTM C384, “Impedance and Absorption of Acoustical Materials by the Impedance Tube Method,” is based on this analogy. It is a relatively simple procedure that measures the sound absorbing properties of small samples of acoustic materials placed inside a long rigid tube. Normal-incidence sound-absorption coefficients are derived from measurements of the standing waves developed when a signal tone is generated in the tube. The method is useful for comparing and evaluating different sound absorbers.

According to “The Fridge Architectural Science Lab,” School of Architecture and Fine Arts, The University of Australia, Online Information and Course Note, by Marsh, A., 1999, http://fridge.arch.uwa.edu.au/topics/acoustics/rooms/absorpton.html, a distinction has to be made between sound absorption, that is, the fraction of sound energy that is actually converted to heat, and the absorption coefficient, which is the fraction of sound energy that is not reflected. The absorption coefficient describes the fraction of sound energy that is either transmitted or absorbed. This distinction is of concern when the sound source is outside the enclosed space, but is less important for applications wherein the sound source is within the enclosed space, and sound reverberation is of importance.

According to Marsh, pervious materials, such as fiberglass, polymeric fiber blankets, and polymeric foams are commonly used as sound absorbers. They are most effective at high frequencies, of short wavelengths, where conversion to heat is produced by friction when vibrating air molecules are forced through and interact with the internal structure of these materials. Sound Absorption may be improved largely by increasing the thickness of the material, or by increasing the resistance to airflow. The latter may be achieved, for example, by increasing the specific weight of the material, or by decreasing the average pore or cell size of foam.

U.S. Pat. Nos. 5,459,291 and 5,824,973, both to Haines et al., describe a method of using a thin, semi-porous film membrane, of controlled airflow resistance, to augment the airflow resistance of an underlying porous insulation. The increased airflow resistance of the laminate results in superior sound absorption properties of the laminate when compared to the porous insulation substrate without the semi-porous membrane.

Abd Technology, whose products may be found at www.abdllc.com/prod01_absorption.htm, offers acoustical foams with different types of film membranes, such as Urethathane film membrane or metalized Mylar film membranes. Unlike the laminate of U.S. Pat. Nos. 5,459,291 and 5,824,973, these are impervious to airflow. Additionally Abd Technology offers a composite, formed of a vinyl barrier, sandwiched between two sheets of foam.

U.S. Pat. Nos. 5,934,338 and 6,057,378 to Perstnev, et al. describe a process for improving the thermal insulation properties of open-cell polymeric foam, by soaking it in a coating solution, which contains particles of a size less than the minimum diametrical length of the passages. The particles, dispersed within the passages, partly block the flow of air between adjacent cells. In this manner, the thermal insulation properties are improved.

Further according to “The Fridge Architectural Science Lab,” by Marsh, hereinabove, at low frequencies, membrane absorbers may be used. These may be flexible sheets, stretched over supports or rigid panes, mounted at some distance from a solid wall. Conversion to heat takes place through the resistance of the membrane to rapid flexing and through the resistance of the enclosed air to compression. These, depend on the density of the membrane and on the width of the enclosed space.

Polymeric foams, fiberglass and mineral wool are commonly used sound absorbers, and their sound absorption characteristics are continuously being improved. Relevant data are shown in Table 1, for Fibrous Glass 4 and open-cell Polyurethane Foam, based on “Noise Control—Technical Information,” http://www.tpcdayton.com/ NoiseConrol/tech_info/ntech.htm, as follows.

| | Frequency, Hz | | | | | | |
|---|---|---|---|---|---|---|---|
| Material | 125 | 250 | 500 | 1000 | 2000 | 4000 | NRC |
| 1″ Fibrous Glass 4 | .07 | .23 | .48 | .83 | .88 | .80 | .60 |
| 2″ Fibrous Glass 4 | .20 | .55 | .89 | .97 | .83 | .79 | .81 |
| 4″ Fibrous Glass 4 | .30 | .91 | .99 | .97 | .94 | .89 | .95 |
| ½″ Polyurethane | .05 | .12 | .25 | .57 | .89 | .98 | .46 |
| Foam (open cell) | | | | | | | |
| 1″ Polyurethane | .14 | .30 | .63 | .91 | .98 | .91 | .70 |
| Foam (open cell) | | | | | | | |
| 2″ Polyurethane | .35 | .51 | .82 | .98 | .97 | .95 | .82 |
| Foam (open cell) | | | | | | | |

As seen in Table 1, reasonable sound absorption, of NRC values of at least 0.80 may be achieved with a sound absorber that is 5 centimeters in thickness. But when good sound absorption in the low frequency range is also desired, a sound absorber of 10 centimeters in thickness may be needed. These values are rather large for many applications. They present a drawback both in terms of space requirement for the sound absorber and ease of installation.

Additionally, mineral wool is a synthetic mineral fiber, a fibrous inorganic substance made primarily from rock, clay, slag or glass. Synthetic mineral fiber are classified into three general groups: fiberglass (glasswool and glass filament), mineral wool (rockwool and slagwool), and refractory ceramic fibers (RCF).

Synthetic mineral fibers are believed to cause respiratory cancers and other adverse respiratory effects. Therefore, attempts are made to limit their manufacturing and use.

Polymeric foams, on the other hand, may ignite and may produce toxic fumes when ignited.

There is thus a widely recognized need for, and it would be highly advantageous to have, a sound absorber devoid of the above limitations.

### SUMMARY OF THE INVENTION

The present invention successfully addresses the shortcomings of the presently known sound absorbers by providing a sound absorbing article, which may be formed to a thickness of between 1 and 2 mm and have an NRC value between 0.8 and 0.9. Additionally the present invention provides for a sound absorbing article formed of materials which are flame retardant and environmentally friendly. Furthermore, the present invention provides for a method of optimizing a sound absorbing article for a particular application and a specific frequency range.

The sound absorbing article of the present invention is advantageous over presently known sound absorbers, because of a unique design which combines at least two physical effects of sound absorption: conversion of sound to friction and heat, as vibrating air molecules are forced through and interact with an internal structure of a pervious material, and conversion of sound to mechanical energy, as vibrating air causes a flexible sheet, stretched over supports, to vibrate.

There is thus provided, in accordance with the present invention, a sound absorbing article, comprising:

(i) a material which is pervious to air, and which is characterized by proximal and distal surfaces with respect to a sound source, an internal structure, and a specific weight; and

(ii) a coating which adheres to the surfaces and internal structure, thus increasing the specific weight by a predetermined factor.

Additionally, in accordance with the present invention, the sound absorbing article comprises a membrane, attached to a surface selected from the distal and proximal surfaces, by bonding at selected bonding locations, thus forming channels between the surface and the membrane.

Additionally, in accordance with the present invention, the channels are interconnected.

There is thus also provided, in accordance with the present invention, a method of manufacturing a sound absorbing article, comprising:

(i) employing a material, which is pervious to air, and which is characterized by proximal and distal surfaces with respect to a sound source, an internal structure, and a specific weight; and

(ii) coating the material with a film which adheres to the surfaces and internal structure, thus increasing the specific weight by a predetermined factor.

Additionally, the method includes attaching at least one membrane to a surface selected from the distal and proximal surfaces, by bonding the membrane only at selected locations, thus forming channels between the surface and the membrane.

There is thus also provided, in accordance with the present invention, a sound absorbing article, comprising:

(i) a material which is pervious to air, and which is characterized by proximal and distal surfaces with respect to a sound source, an internal structure, and a specific weight; and

(ii) a membrane attached to a first surface, selected from the group consisting of said proximal and distal surfaces, at selected bonding locations, forming channels between said membrane and said first surface.

Additionally, in accordance with the present invention, the membrane is impervious to air.

Further in accordance with the present invention, the channels are interconnected.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1A-1D are illustrations of sound-absorbing articles, according to preferred embodiments of the present invention;

FIGS. 2A-2B are illustration of apparatus for applying a coating to a sound absorbing article, according to preferred embodiments of the present invention;

FIGS. 3A-3B are illustrations of apparatus for bonding a membrane to a sound absorbing article, according to preferred embodiments of the present invention;

FIG. 4 is an illustration of a sound-absorbing article according to another preferred embodiment of the present invention;

FIGS. 5A and 5B illustrate, in tabular forms, experimental results for sound absorbing articles formed of nonwoven polyester, coated with water glass, according to preferred embodiments of the present invention;

FIG. 6 illustrates, in graphical forms, the experimental results of FIGS. 5A and 5B;

FIGS. 7A and 7B illustrate, in tabular forms, experimental results for sound absorbing articles formed of nonwoven polyester, coated with a mixture of water glass and hydrated alumina, according to other preferred embodiments of the present invention;

FIG. 8 illustrates, in graphical forms, the experimental results of FIGS. 7A and 7B;

FIGS. 9A and 9B illustrate, in tabular forms, experimental results for sound absorbing articles formed of open-cell foam, coated with a mixture of water glass and hydrated alumina, according to still other preferred embodiments of the present invention;

FIG. 10 illustrates, in graphical forms, the experimental results of FIGS. 9A and 9B;

FIGS. 11A and 11B illustrate, in tabular forms, experimental results for sound absorbing articles formed of nonwoven polyester, coated with a mixture of water glass and hydrated alumina, bonded to a membrane at varying distances, according to yet other preferred embodiments of the present invention;

FIG. 12 illustrates, in graphical forms, the experimental results of FIGS. 11A and 11B;

FIGS. 13A and 13B illustrate, in tabular forms, experimental results for sound absorbing articles formed of nonwoven polyester, coated with a mixture of water glass and hydrated alumina, attached to a honeycomb, according to other preferred embodiments of the present invention; and

FIG. 14 illustrates, in graphical forms, the experimental results of FIGS. 13A and 13B.

### DETAILED DESCRIPTION OF PREFERRED EMBODIMENTS

The present invention provides for a sound absorbing article, which may be formed to a thickness of between 1 and 2 mm and have an NRC value between 0.8 and 0.85. Additionally the present invention provides for a sound absorbing article formed of materials which are flame retardant and environmentally friendly. Furthermore, the present invention provides for a method of optimizing a sound absorbing article for a particular application and a specific frequency range.

The sound absorbing article of the present invention is advantageous over presently known sound absorbers, because of a unique design which combines at least two physical effects of sound absorption: conversion of sound to friction and heat, as vibrating air molecules are forced through and interact with an internal structure of a pervious material, and conversion of sound to mechanical energy, as vibrating air causes a flexible sheet, stretched over supports, to vibrate.

Before explaining at least one embodiment of the invention in detail, it is to be understood that the invention is not limited in its application to the details of construction and the arrangement of the components set forth in the following description or illustrated in the drawings. The invention is capable of other preferred embodiments or of being practiced or carried out in various ways. Also, it is to be understood that the phraseology and terminology employed herein is for the purpose of description and should not be regarded as limiting.

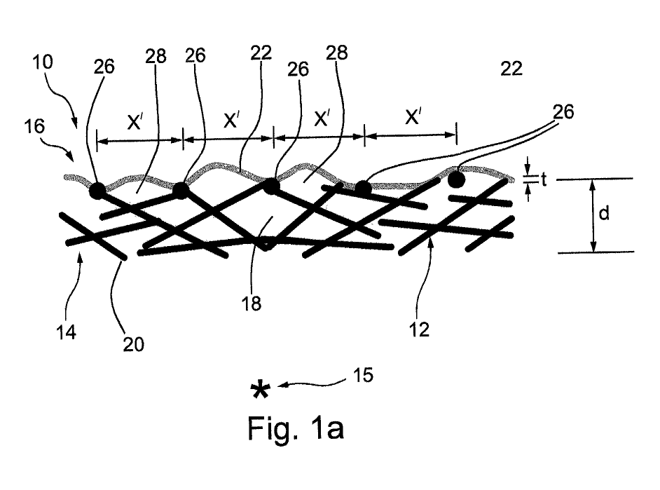

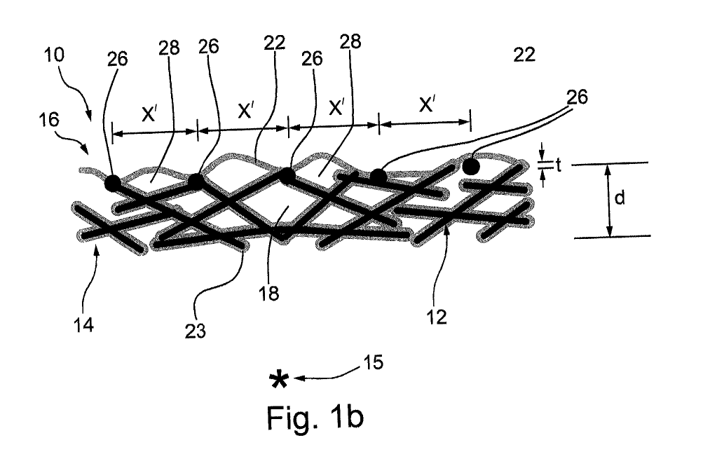

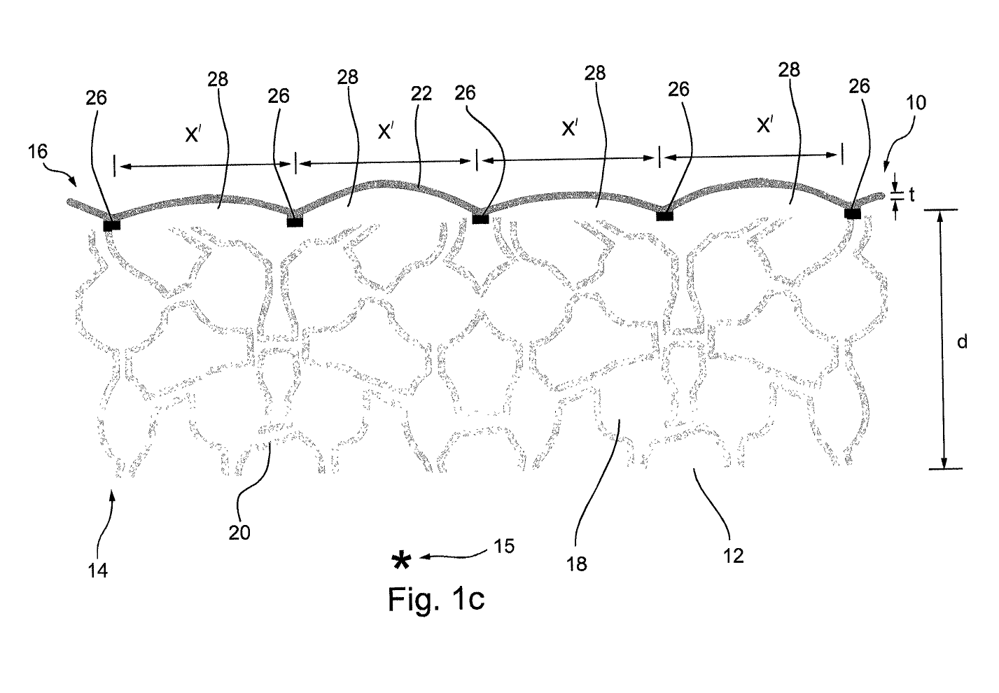

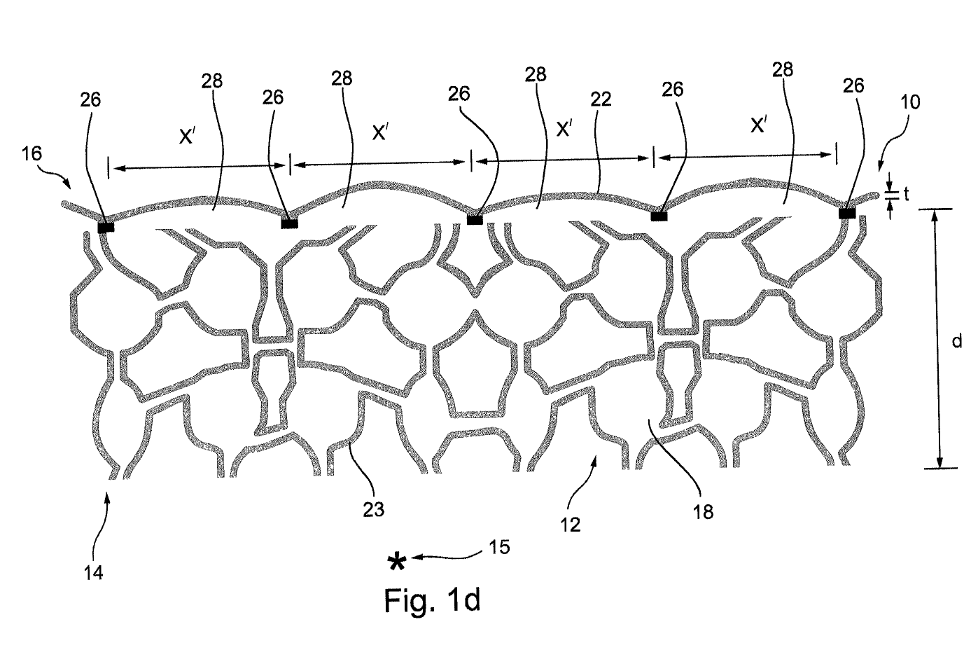

Referring now to the drawings, FIG. 1A illustrates a sound-absorbing article 10, according to a preferred embodiment of the present invention. Sound absorbing article 10 is formed of a material 12, which is pervious to air flow, and which is characterized by proximal and distal surfaces 14 and 16, with respect to a sound source 15, a width d, an internal structure 18, and a specific weight W (not shown).

According to a preferred embodiment of the present invention, material 12 comprises a fibrous material. Further according to a preferred embodiment of the present invention, material 12 comprises nonwoven polyester. However, according to other preferred embodiments of the present invention, material 12 may comprise another fibrous material or foam as will be described hereinbelow.

According to a preferred embodiment of the present invention, width d is between 1 and 2 mm, for example, 1.6 mm. However, according to other preferred embodiments of the present invention, width d may be less than 1 mm, for example, 0.4 mm. Alternatively, width d may be greater than 2 mm, and may be as large as needed for a specific application. For example, width d may be 3 mm, or 50 mm, or more than 100 mm.

As seen in FIG. 1A, material 12 further comprises a coating 20, which adheres to surfaces 14 and 16 and to internal structure 18, so as to increase specific weight W. Preferably, specific weight W is increased by a factor that yields optimal sound absorption characteristics for a specific application. According to a preferred embodiment of the present invention, specific weight W is increased by a factor between 3 and 9. However, according to other preferred embodiments of the present invention, specific weight W may be increased by a factor of 1.25, or by a far greater factor, for example, 10, or 12.

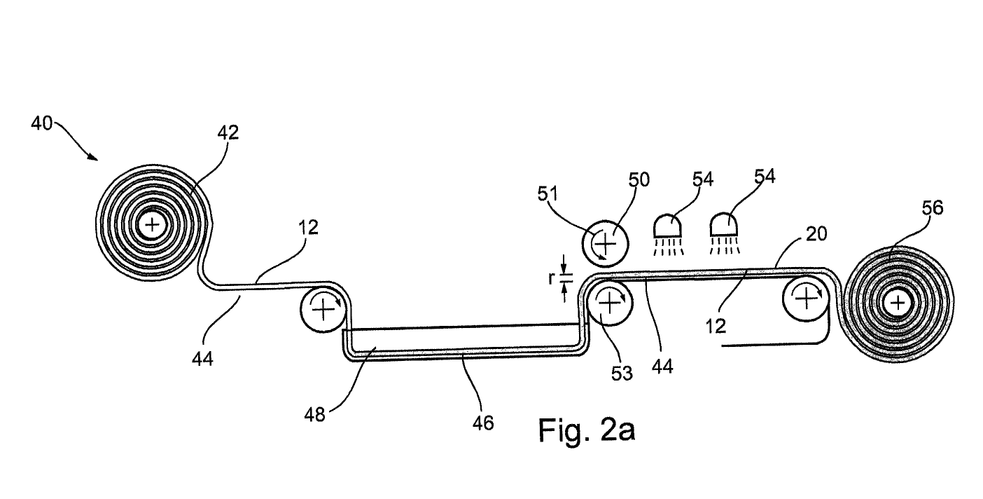

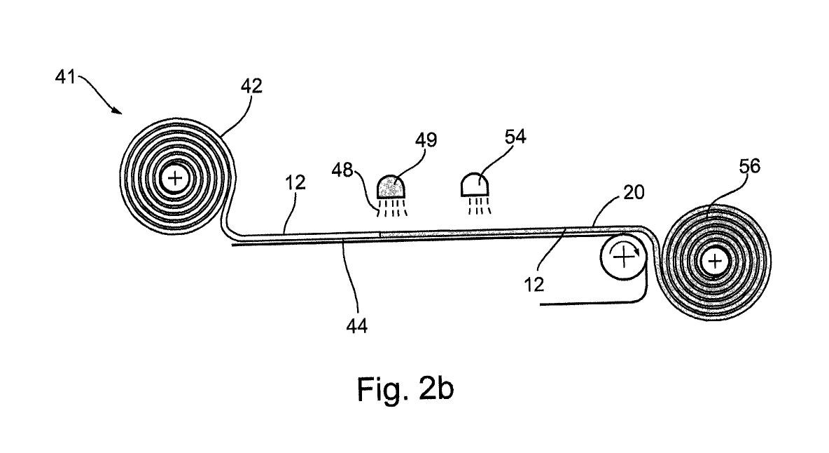

As will be described hereinbelow, in conjunction with FIG. 2A, coating 20 may be formed by soaking material 12 in a liquid coating solution 48 of a liquid adhesive, so as to impregnate material 12 with coating 20, then allowing material 12 to dry. Alternatively, as will be described hereinbelow, in conjunction with FIG. 2B, coating 20 may be formed by spraying material 12 with coating solution 48 of a liquid adhesive, so as to impregnate material 12 with coating 20, then allowing material 12 to dry.

Coating 20 is a novel feature of the present invention. According to “The Fridge Architectural Science Lab,” School of Architecture and Fine Arts, The University of Australia, Online Information and Course Note, by Marsh, A., 1999, http://fridge.arch.uwa.edu.au/topics/acoustics/rooms/absorpton.html, sound absorption characteristics of materials, which are pervious to air flow, may be improved by increasing the resistance to air flow. The resistance to airflow, in turn, is increased with increasing specific weight. Coating 20 is operative to increase the specific weight of material 12 by a predetermined factor.

According to a preferred embodiment of the present invention, coating 20 comprises a silicate compound, for example, water glass.

Water glass is chiefly produced as sodium silicate. It is a colorless, transparent, grasslike salt, available commercially as a water-soluble powder or as a transparent, viscous solution in water. Chemically it is any one of several compounds containing sodium oxide, Na2O, and silica, Si2O, or a mixture of sodium silicates. The sodium silicates may be, for example, Sodium orthosilicate (Na4SiO4 or 2Na2O.SiO2), sodium metasilicate (Na2SiO3 or Na2O.SiO2), sodium disilicate (Na2Si2O5 or Na2O.2SiO2), and (or) sodium tetrasilicate (Na2Si4O9 or Na2O.4SiO2). All these compounds are transparent, glassy or crystalline solids that have high melting points (above 800° C.) and are water soluble. They are produced chiefly by fusing sand and sodium carbonate in various proportions, or by heating sodium hydroxide with sand under pressure. Sodium silicate is very soluble in water. It hardens to a film of high adhesion, and high resistance to heat, weather, and fire.

Water glass is also commercially available as potassium silicate, produced, for example, by fusing sand and potassium carbonate in various proportions, or by heating potassium hydroxide with sand under pressure. Similarly, water glass is commercially available as lithium silicate. These products are also very soluble in water. They too harden to films of high adhesion, and high resistance to heat, weather, and fire.

Additionally, water glass is commercially available as a mixture, for example of sodium silicate and potassium silicate.

Additionally, other silicate compounds may be used to form coating 20. For example, Cesium oxythiomolybdate, Cs2MoOSi3, which is a solid lubricant film at high temperatures, of about 600° C. may be used to form coating 20. It is a mostly amorphous film with excellent film adhesion. Similarly, calcium silicate, which hardens to an amorphous silica film which is heat resistant to temperatures of about 1,500° C. and which is highly weather resistant, may be used to form coating 20. Additionally, other silicate compound, or a mixture of several silicate compounds may be used to produce coating 20.

According to other preferred embodiments of the present invention, coating 20 may be formed of other substances or mixtures that have adhesive properties, so as to adhere to surfaces 14 and 16 and to internal structure 18, and increase specific weight W. These may be, for example, natural resins, chemically modified natural resins, synthetic resins, and a mixture of these. For example, coating 20 may comprise acrylic adhesives, other polymeric adhesives, or other known adhesives. In particular, an acrylic adhesive known as T1633, which is flame retardant, or another flame retardant resin may be used.

Additionally, according to a preferred embodiment of the present invention, coating 20 may be selected based on its heat, fire, and weather resistance for a particular application, or based on its resistance to specific environmental conditions, for example, vapor, or acid fumes.

Other features of FIG. 1A are described hereinbelow, in conjunction with FIGS. 1A-1D.

Referring further to the drawings, FIG. 1B illustrates a sound-absorbing article 10, according to a second preferred embodiment of the present invention. Sound absorbing article 10 is formed of a material 12, which is pervious to air flow, and which is coated with a coating 23, comprising a mixture of an adhesive and a flame-retardant agent. Coating 23 is operative to adhere to surfaces 14 and 16 and to internal structure 18, and increase specific weight W, while acting as a flame retardant.

Preferably, the flame-retardant agent is mixed with an adhesive, in a liquid form, to make coating solution 48 (FIGS. 2A and 2B, hereinbelow). The mixture composition may be predominantly adhesive, or predominantly flame-retardant agent, but sufficient adhesive is used in the mixture to ensure good adhesion to material 12, to form a coating. Thus, the flame-retardant agent and the adhesive may be mixed so that the flame-retardant agent forms between 10 and 90% of the mixture.

According to an article by “The National Academies Office of News and Public Information”,edited by Hicks, C., and Roberts, T., and produced online by Solheim, S, .www4.nationalacademies.org/news.nsf/isbn, on Apr. 27, 2000, eight flame-retardant chemicals can safely be used on upholstered furniture, while posing little or no health risk to people who may be exposed to them in the home. The eight chemicals include the aforementioned alumina trihydrate and zinc borate ,and further include, hexabromocyclododecane, decabromodiphenyl oxide, magnesium hydroxide, ammonium polyphosphates, phosphoric acid, and tetrakis hydroxymethyl phosphonium chloride. Although toxicity data for some of them are inadequate for certain routes of exposure, these chemicals were found to be safe even under the worst-case exposure assumptions. In accordance with preferred embodiments of the present invention, any of the aforementioned eight chemicals may be used as the flame-retardant agent. Additionally, other flame-retardant agents, or fire and flame-retardant agents that pose little or no health risk may be used.

For example, the flame-retardant agent may comprise hydrated alumina, such as aluminum trihydroxides, Al(OH)3. Hydrated alumina is a non-smoking, low toxicity halogen free flame retardant. When a plastic, treated with hydrated alumina is exposed to fire, the hydrate begins to decompose endothermically into water and anhydrous alumina. The water acts as a heat sink, cooling the plastic and significantly slowing its degradation into combustible fuel.

Alternatively, Zinc Borate, which is non-toxic, flavorless, odorless, non-corrosive, and non-irritant, having the molecular formula, 2Zn0.3B2O3.3.5H2O2, or the molecular formula 2Zn0.3B2O3.7H2O, may be used.

Alternatively, Seize Fyre 5050, which is a water-soluble co-polymer blend of ammonium polyphosphates may be used. It's supplier is Seize Fyre, www.firenomore.com/flameretardantsapplications.htm.

In accordance with other embodiments of the present invention, any known flame retardant or fire and flame-retardant agent may be used.

In accordance with some embodiments of the present invention, the flame retardant or fire and flame-retardant agent may be soluble in liquid coating solution 48, (FIGS. 2A and 2B, hereinbelow.) Other features of FIG. 1B are described hereinbelow, in conjunction with FIGS. 1A-1D.

Referring now to the drawings, FIG. 1C illustrates a sound-absorbing article 10, according to a another preferred embodiment of the present invention, wherein material 12 is a foam 12, which is pervious to air flow. Foam 12 further includes proximal and distal surfaces 14 and 16, internal structure 18 and specific weight W (not shown). Foam 12 is coated with a coating 20, operative to adhere to surfaces 14 and 16 and to internal structure 18, and increase specific weight W. Coating 20 may be formed of a silicate compound, such as water glass, or another adhesive, as has been described hereinabove, in conjunction with FIG. 1A.

Other features of FIG. 1C are described hereinbelow, in conjunction with FIGS. 1A-1D.

Referring now to the drawings, FIG. 1D illustrates a sound-absorbing article 10, according to a another preferred embodiment of the present invention, wherein material 12 is foam 12, coated with a coating 23, comprising a mixture of an adhesive and a flame-retardant agent and operative to adhere to surfaces 14 and 16 and to internal structure 18, and increase specific weight W, while acting as a flame retardant, as has been described hereinabove, in conjunction with FIG. 1B.

As seen in FIGS. 1A-1D, a membrane 22 is attached to material 12. Preferably membrane 22 is impervious to airflow, and is attached only at selected bonding locations 26. Thus, channels 28 are formed between material 12 and membrane 22. Additionally, in accordance with the present invention, channels 28 are interconnected, allowing air to pass through them.

Furthermore, membrane 22 is preferably attached to distal surface 16.

Membrane 22 is another novel feature of the present invention. As air, flowing through material 12, strikes membrane 22, it causes membrane 20 to vibrate as a flexible sheet, thus converting sound energy to mechanical energy and further increasing the sound absorption characteristics article 10. Additionally, membrane 20 increases the overall resistance of article 10 to airflow, since the air must force its way through interconnected channels 28, formed between membrane 22 and material 12, encountering friction so as to add to the conversion of sound absorption energy to heat.

According to a preferred embodiment of the present invention, membrane 22 is formed of polyethylene, and has a thickness t of substantially 20μ. According to other preferred embodiments of the present invention, membrane 22 may comprise a natural rubber, a chemically modified natural rubber, a synthetic polymer, a metal foil, Mylar, PVC, a metalized polymer, a laminated sheet of metal and polymer, or another known flexible material, which is impervious to airflow. Further according to other preferred embodiments of the present invention, membrane 22 may be formed to a thickness between 5 and 40μ.

According to other preferred embodiments of the present invention, membrane 22 may be attached to proximal surface 14. Additionally, membrane 22 may be semipervious.

According to a preferred embodiment of the present invention, bonding locations 26, at which membrane 22 is attached to material 12, may be formed as bonding points 26, and may be evenly distributed, with distances X′ between points.

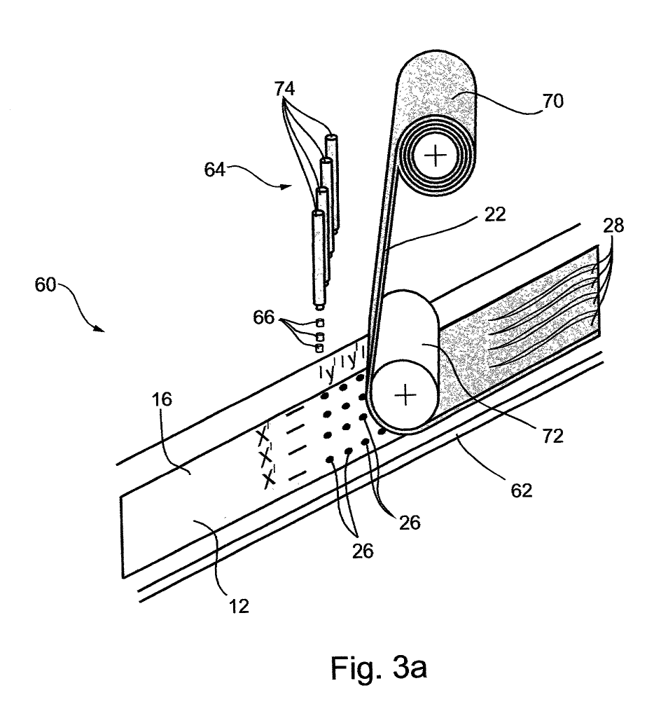

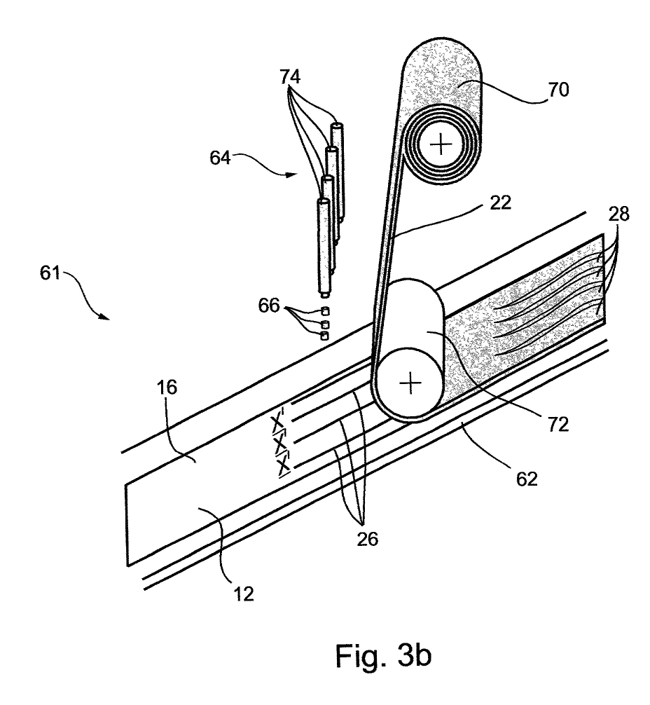

Additionally, bonding points 26 may be evenly distributed, with distances X′ between points in a first direction (as shown in FIGS. 1A-1D) and with distances Y′ between points in a second direction, orthogonal to the first direction (running into the paper in FIGS. 1A-1D, but shown hereinbelow, in conjunction with FIG. 3A).

Preferably, both distances X′ and Y′ are substantially 1.5 cm. However, according to other preferred embodiments of the present invention, points 26 may be closer to each other, or farther apart, and distances X′ and Y′ need not be the same. For example, distance X′ may be 0.4 cm, and distance Y′ may be 3 cm. In accordance with the present invention, distances X′ and Y′ may be between 0.1 cm and 20 cm.

In accordance with another preferred embodiment of the present invention, bonding locations 26 are formed as bonding lines 26, with distances X′ between them. Alternatively, any other geometry of bonding membrane 22 to material 12 at selected locations may be employed. For example, broken lines 22, in a first direction, or a mixture of broken lines in a first direction and an orthogonal direction. Alternatively, bonding locations 26 may be randomly distributed on distal surface 16 or proximal surface 14.

Referring further to the drawings, FIG. 2A illustrates apparatus 40 for applying coating 20 or coating 23 (FIG. 1B or 1D) to material 12, according to a preferred embodiment of the present invention. Preferably, uncoated material 12 unravels from a spool 42 onto a conveyer belt 44, which leads it onto a bath 46 of a coating solution 48, for soaking, preferably, until material 12 is thoroughly soaked.

Material 12 exits bath 46, via conveyer belt 44, which includes a roller system 50, having first and second rollers 51 and 53, set with a spacing r between them, operative to wring out excess solution 48. According to a preferred embodiment of the present invention, the factor by which specific weight W is increased is predetermined by distance r of roller system 50. Additionally, distance r may be varied to control the increase in specific weight.

Material 12 continues to travel on conveyer belt 44 for a predetermined period of time to air dry. Additionally, an air blower system 54 may be used to speed up the drying process. When dried, coated material 12 may be rolled unto a spool 56.

According to the present invention, coating solution 48 comprises a liquid adhesive, for example, water glass dissolved in water, or a liquid acrylic adhesive, or any other adhesive described in conjunction with FIG. 1A, in its liquid form, to form coating 20.

Alternatively, according to the present invention, coating solution 48 may further comprise the flame-retardant agent, or a fire and flame retardant agent, such as water-soluble Seize Fyre 5050, or hydrated alumina, or any other flame-retardant agent, or a fire and flame retardant agent, described in conjunction with FIG. 1B, to form coating 23.

Referring further to the drawings, FIG. 2B illustrates alternative apparatus 41 for applying coating 20 or coating 23 (FIG. 1B or 1D) to material 12, according to another preferred embodiment of the present invention.

In accordance with the present embodiment, uncoated material 12 unravels from spool 42 onto conveyer belt 44, which runs under a spray system 49, for spraying coating 48 onto material 12, at a predetermined rate. The spraying rate of spray system 49 and the travel rate of conveyer belt 44 together determine the factor by which specific weight W is increased. Material 12 may be air dried by air blower system 54. When dried, coated material 12 may be rolled unto spool 56.

It will be appreciated that coating 48 may be applied to material 12 at the manufacturing site of material 12, for example, during the manufacturing process of material 12, or at a manufacturing site of sound absorbing article 10.

It will be appreciated that another known system for impregnating material 12 with coating solution 48 may be used. Additionally, impregnating may be performed by hand.

Referring further to the drawings, FIG. 3A illustrates apparatus 60 for attaching membrane 22 to material 12, according to a preferred embodiment of the present invention.

Preferably, material 12 unravels, for example from spool 56 (FIG. 2A) onto a conveyer belt 62. A drip system 64 drips a bonding liquid 66 onto distal surface 16 of material 12, forming bonding locations 26, in the form of bonding points 26.

According to a preferred embodiment of the present invention, drip system 64 comprises a plurality of dripping devices 74, arranged with distance X′ between any two devices 74. Thus, the dripped points are also arranged with distance X′ between two points, in a first direction. Additionally, dripping devices 74 drip bonding liquid 66 at a specific dripping rate. The dripping rate, together with a travel rate of conveyer belt 62 determine a distance Y′ between two points, in a direction orthogonal to the first direction.

Thus, the density of points 26 on distal surface 16 may be controlled by varying the number of dripping devices 74 and the distance between them, or by varying the dripping rate, or varying the travel rate of conveyer belt 62.

Membrane 22 is unraveled from a spool 70, and is pressed against surface 16 of material 12, by a roller 72, bonding to material 12 at locations 26. Thus, channels 28 are formed between material 12 and membrane 22.

Referring further to the drawings, FIG. 3B illustrates apparatus 61 for attaching membrane 22 to material 12, according to another preferred embodiment of the present invention, wherein bonding locations 26, are formed as parallel bonding lines 26, arranged with distance X′ between two lines.

It will be appreciated that any other geometry of bonding membrane 22 to material 12 at selected locations may be employed. For example, dripping system 74 may be arranged to form broken lines 26, by varying the dripping rate. Additionally, or alternatively, dripping system 74 may be rotated or moved across material 12 to form swirls of bonding locations, or lines or broken lines in a first direction and in another direction. Alternatively, dripping system 74 may be arranged to randomly drip bonding liquid 66 on material 12.

It will be appreciated that another known system for bonding membrane 22 to material 12 may be used. Additionally, bonding may be performed by hand.

It will be appreciated that apparatus 60 or 61, or another system of applying bonding locations to material 12 may similarly be used for applying bonding locations to proximal surface 14.

It will be appreciated that apparatus 40 (FIG. 2A) or 41 (FIG. 2B) on the one hand, and apparatus 60 (FIG. 3A) or 61 (FIG. 3B) on the other hand, may be combined into a single apparatus, for coating material 12 and bonding membrane 22 onto material 12 in a single apparatus.

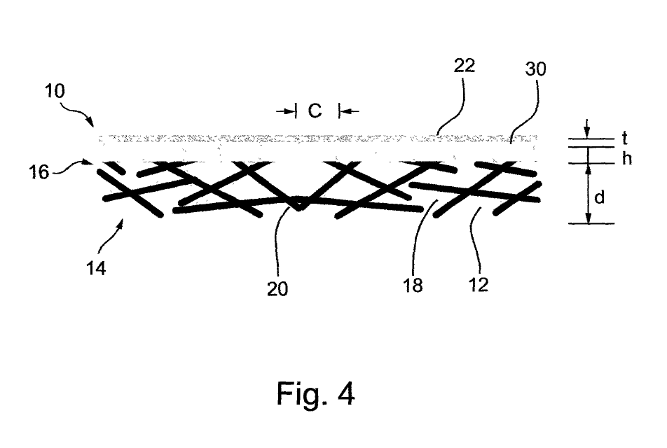

Referring further to the drawings, FIG. 4 illustrates a sound absorbing article 10, according to a second preferred embodiment of the present invention, wherein sound absorbing article 10 further comprises a rigid honeycomb 30, arranged between coated material 12 and membrane 22. Rigid honeycomb 30 comprises a height h and an effective cell diameter c.

Rigid honeycomb 30 is another novel feature of the present invention, operative to provide sound absorbing article 10 with stiffness, making it self-supporting.

According to the preferred embodiment of the present invention, rigid honeycomb 30 is formed of kraf paper, for example, of between 80 and 220 gram/m². Its effective cell diameter c, may be between 0.5 and 3 cm, preferably, 1.5 cm, and its height h may be between 0.5 and 6 cm, preferably, 1.5 cm. However, according to other preferred embodiments of the present invention, rigid honeycomb 30 may be formed of a rigid plastic, or another rigid material, and may be formed to other dimensions.

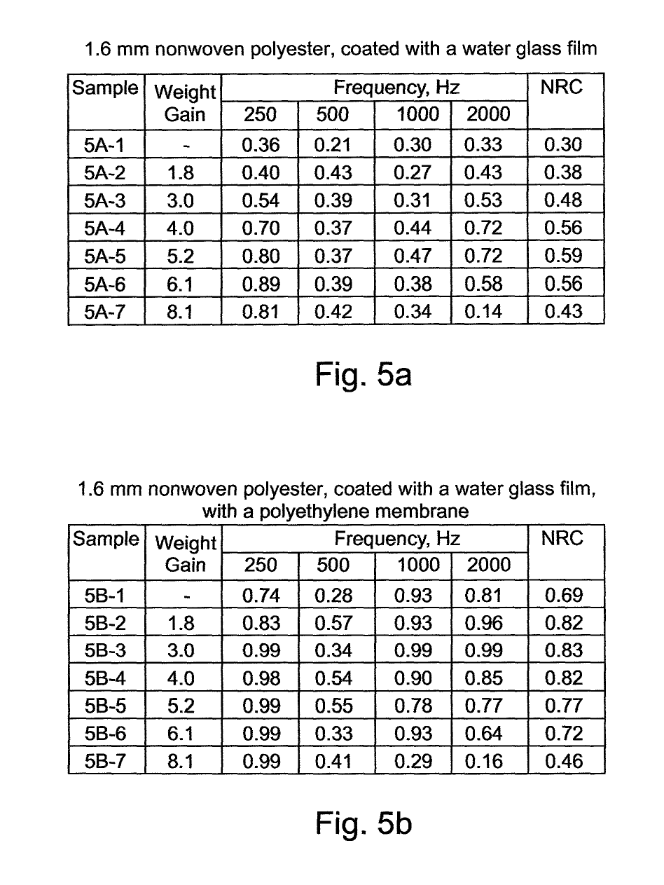

Additional objects and advantages of the present invention will become apparent to one ordinarily skilled in the art upon examination of the following experimental results of specific examples, presented in tabular and graphical forms, in FIGS. 5A-14, without intending to be limiting, as follows:

FIGS. 5A and 5B illustrate, in tabular forms, experimental results for sound absorbing articles 10 (FIG. 1A) formed of a nonwoven polyester, with and without membrane 22. Material 12 has a thickness d of substantially 1.6 mm, is coated with water glass of sodium silicate, to different specific-weight gains, according to preferred embodiments of the present invention. Membrane 22 is formed of polyethylene, to thickness t of substantially 20μ.

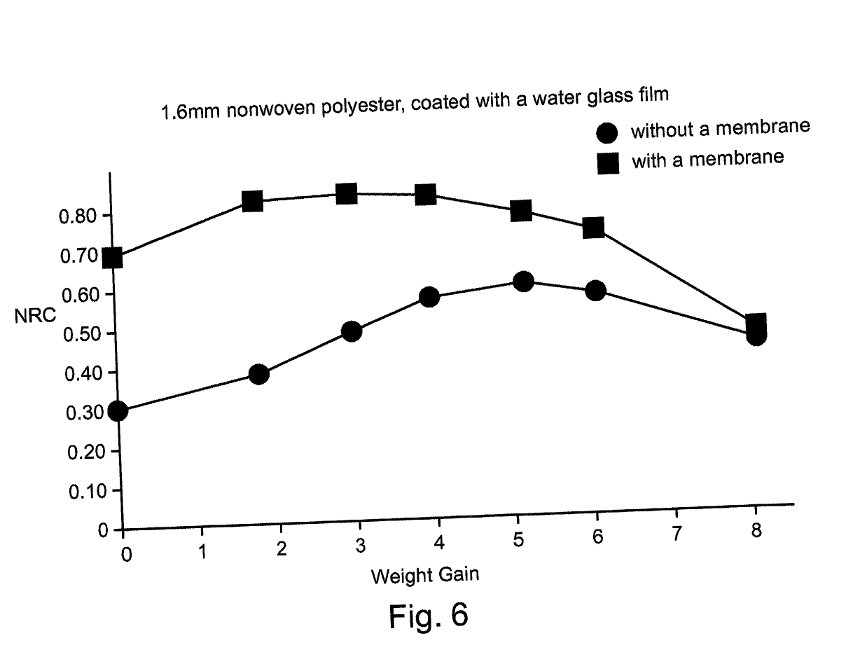

FIG. 6 illustrates, in graphical forms, the experimental results of FIGS. 5A and 5B.

As seen from FIGS. 5A-5B and 6, coating 20 has an appreciable effect on the NRC values. Whereas the uncoated sound absorbing article has an NRC value of substantially 0.30, that coated to a specific-weight gain factor of 5.2 has an NRC value of substantially 0.59, about twice the uncoated value. The effect of coating 20 reaches a maximum at a specific-weight gain factor of substantially 5.2.

Furthermore, membrane 22 has an additional effect, increasing the NRC values from substantially 0.30 to substantially 0.69 for uncoated materials, and from substantially 0.48 to substantially 0.83 for material coated to a specific-weight gain factor of 3. The combined effect of coating 20 and membrane 22 reaches a maximum at a specific-weight gain factor of substantially 3.

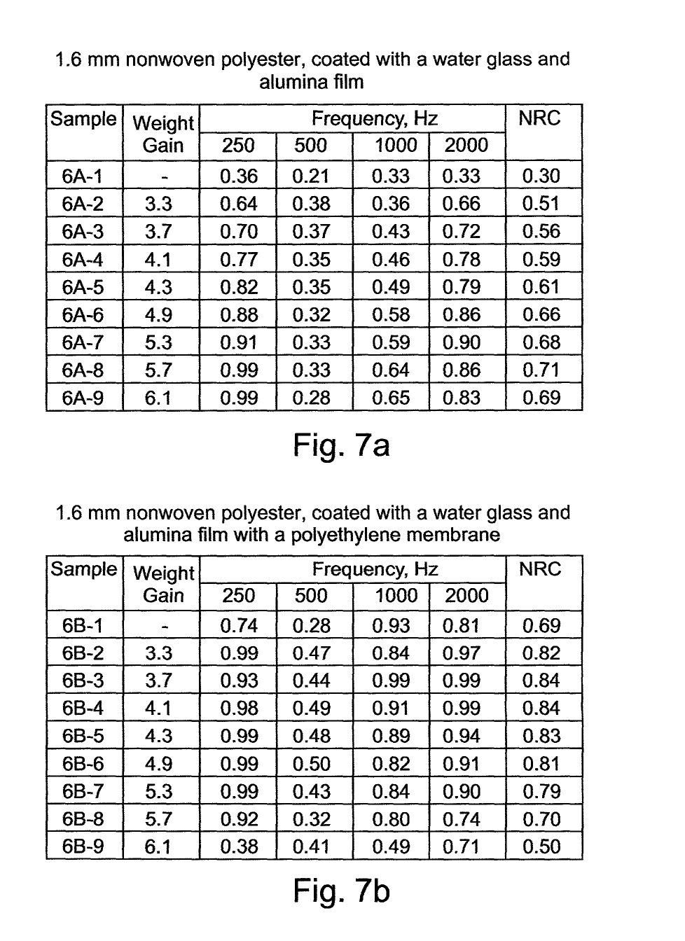

FIGS. 7A and 7B illustrate, in tabular forms, experimental results for sound absorbing articles 10 (FIG. 1B) formed of a nonwoven polyester, with and without membrane 22. Material 12 has a thickness d of substantially 1.6 mm, is coated with a mixture of about 60% water glass of sodium silicate and about 40% hydrated alumina, by weight, to different specific-weight gains, according to preferred embodiments of the present invention. Membrane 22 is formed of polyethylene, to thickness t of substantially 20μ.

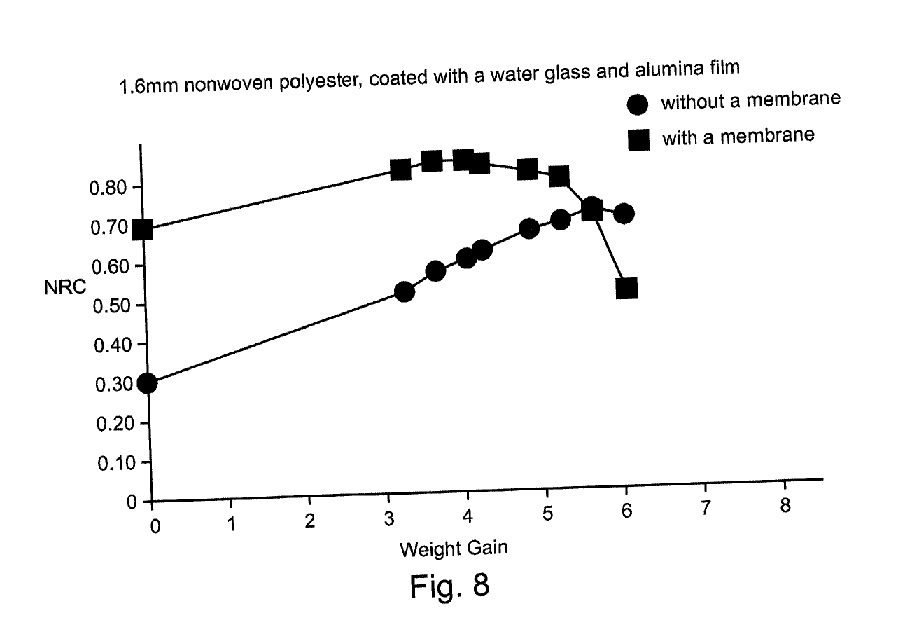

FIG. 8 illustrates, in graphical forms, the experimental results of FIGS. 7A and 7B.

When comparing FIGS. 7A-7B and 8 with FIGS. 5A-5B and 6, it appears that there is a small effect to the composition of the coating, for example, the composition of coating 20 (FIGS. 1A, 5A-5B and 6), compared with that of coating 23 (FIGS. 1B, 7A-7B and 8). Thus for coating 20, a maximum NRC value of 0.59 is obtained, at a specific-weight-gain factor of 5.2, while for coating 23, a maximum NRC value of 0.71 is obtained, at a specific-weight-gain factor of 5.7. However, this effect becomes insignificant with the addition of membrane 22, yielding maximum NRC values of substantially 0.83, for specific-weight-gain factors between 2 and 4 for both coating 20 and coating 23.

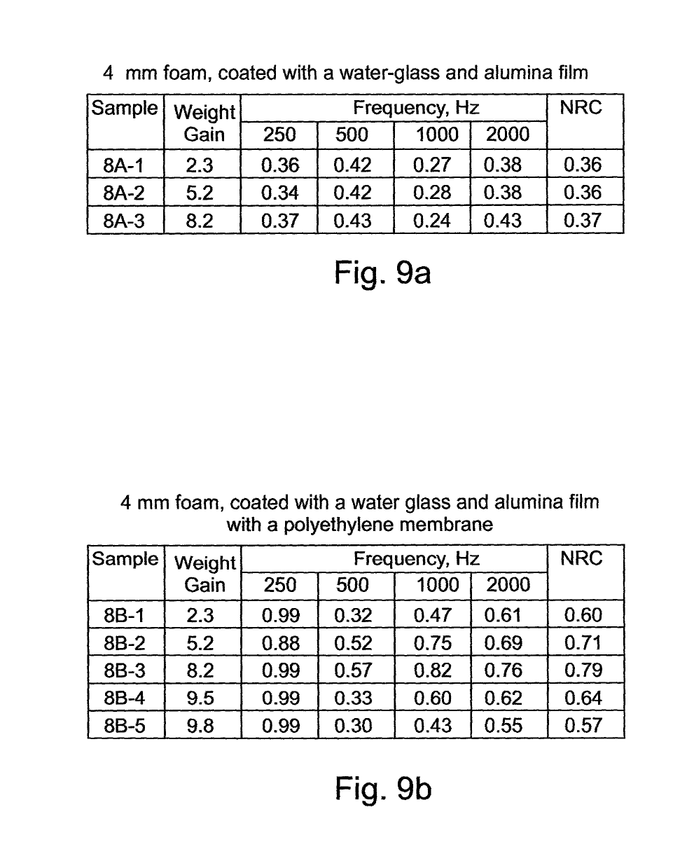

FIGS. 9A and 9B illustrate, in tabular forms, experimental results for sound absorbing articles 10 (FIG. 1D) formed of an open-cell polyurethane foam of 18 kg/m², with and without membrane 22. Material 12 has a thickness d of substantially 4 mm, is coated with a mixture of about 40% water glass of sodium silicate and about 60% hydrated alumina, by weight, to different specific-weight gains, according to preferred embodiments of the present invention. Membrane 22 is formed of polyethylene, to thickness t of substantially 20μ.

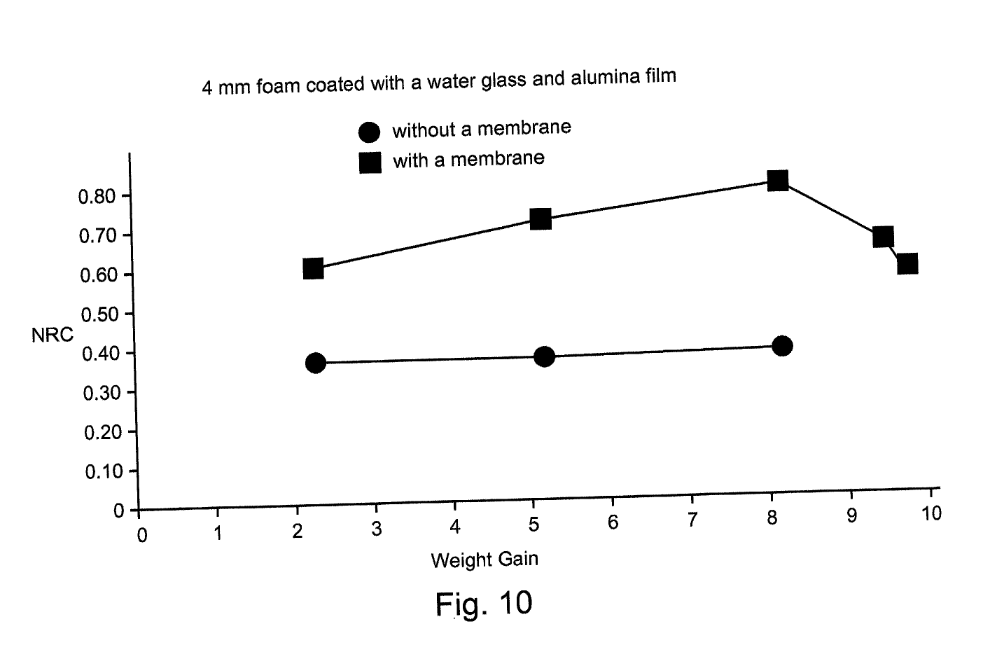

FIG. 10 illustrates, in graphical forms, the experimental results of FIGS. 9A and 9B.

As seen from FIGS. 9A-9B and 10, coating 23 has little effect on foam. Both the uncoated and the coated sound absorbing articles have NRC values of substantially 0.36. However, the addition of membrane 22 has a significant effect, which increases with the specific-weight-gain factor. Thus, at a specific-weight-gain factor of 8.2 the NRC value of the foam reaches 0.79, compared with 0.30 for uncoated foam with no membrane 22, and compared with 0.69 for uncoated foam with membrane 22.

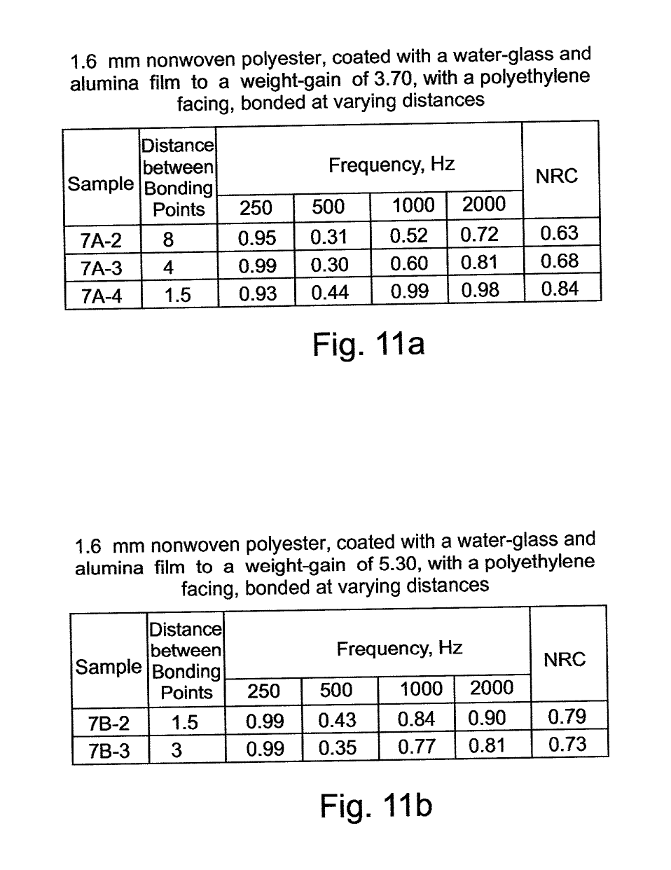

FIGS. 11A and 11B illustrate, in tabular forms, experimental results for sound absorbing articles 10 (FIG. 1B) formed of a nonwoven polyester, with membrane 22, bonded at varying distances X′ between bonding points 26. Material 12 has a thickness d of substantially 1.6 mm, is coated with a mixture of about 60% water glass of sodium silicate and about 40% hydrated alumina, by weight, according to preferred embodiments of the present invention. Membrane 22 is formed of polyethylene, to thickness t of substantially 20μ. FIG. 11A relates to a specific-weight gain of a factor of 3.7, and FIG. 11B relates to a specific-weight gain of a factor of 5.3.

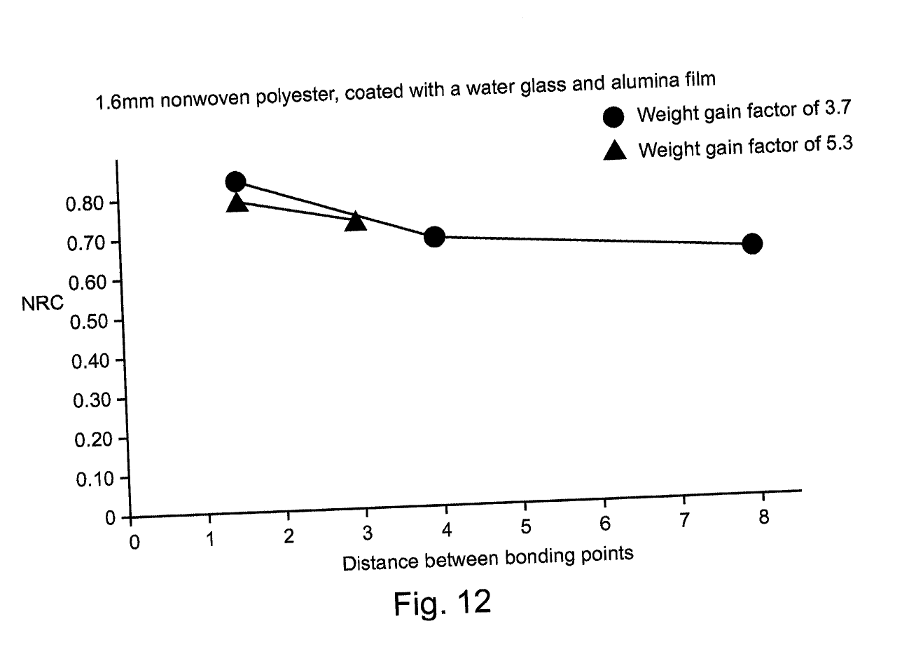

FIG. 12 illustrates, in graphical forms, the experimental results of FIGS. 11A and 11B.

As seen in FIGS. 11A-11B and 12, the optimal value for X′ is 1.5 cm.

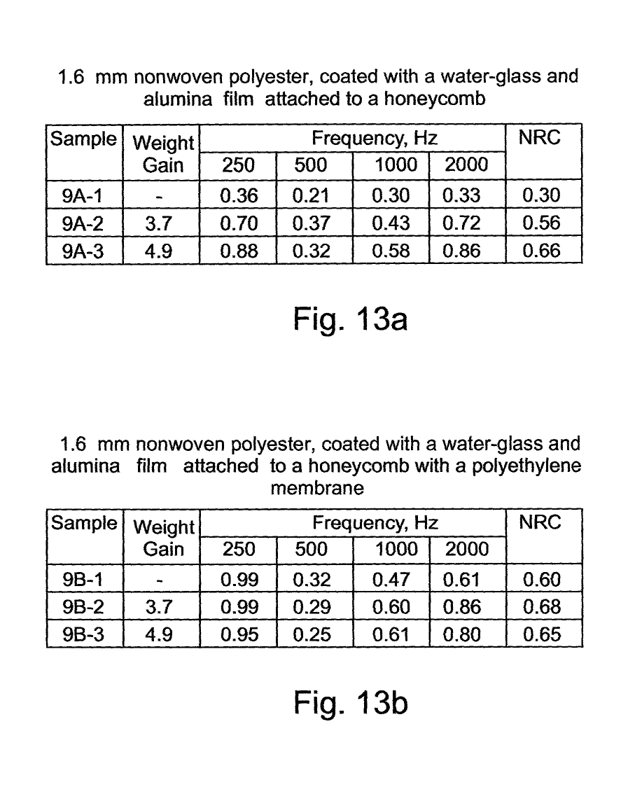

FIGS. 13A and 13B illustrate, in tabular forms, experimental results for sound absorbing articles 10 (FIG. 4) formed of a nonwoven polyester, with and without membrane 22. Material 12 has a thickness d of substantially 1.6 mm, is coated with a mixture of about 60% water glass of sodium silicate and about 40% hydrated alumina, by weight, to different weight gains, according to preferred embodiments of the present invention. Membrane 22 is formed of polyethylene, to thickness t of substantially 20μ. Honeycomb 30 is formed of kraf paper of 147 g/m² wherein height h is 2 cm and effective cell diameter c is 1.5 cm.

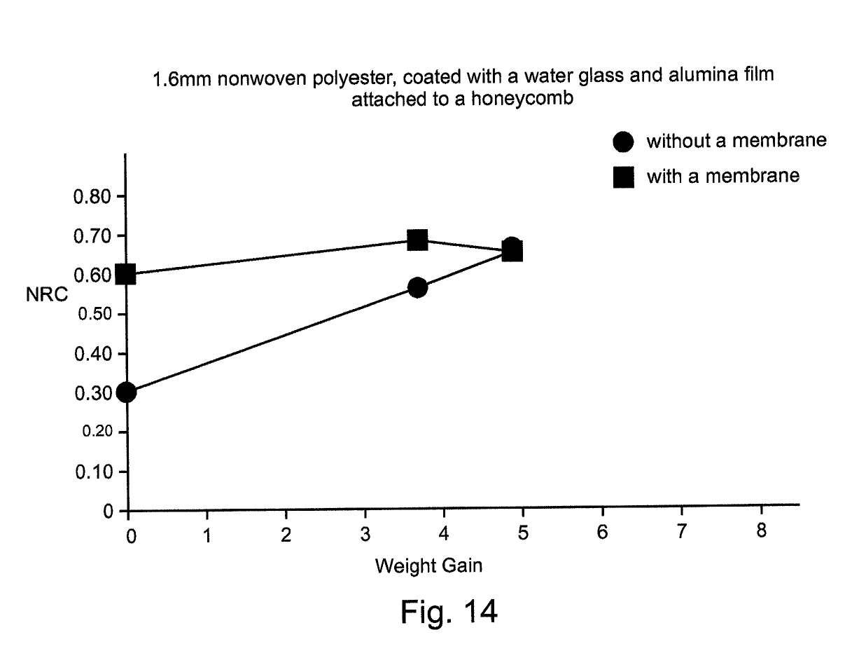

FIG. 14 illustrates, in graphical forms, the experimental results of FIGS. 13A and 13B.

When comparing FIGS. 13A-13B and 14 with FIGS. 7A-7B and 8, which have no honeycomb, it appears that honeycomb 30 does not effect the NRC values for the examples without membrane 22 and lowers them somewhat for the example with membrane 22. The purpose of honeycomb 30 is to give sound absorbing article 10 stiffness and structural strength, while maintaining reasonable NRC values.

The present invention further provides for optimizing a sound absorbing article for a particular application and a specific frequency range, by selecting an article of maximum or desired sound absorption coefficient from FIGS. 5A-14, or similarly obtained figures. For example, with regard to FIG. 5A, although a maximum NRC value is obtained at a specific-weight-gain factor of 5.2, for the frequency range of 250 Hz, the maximum sound absorption coefficient is obtained at a specific-weight-gain factor of 6.1. A designer may choose to optimize either the NRC value or the coefficient at a specific frequency, or weigh one against the other.

According to a preferred embodiment of the present invention, material 12, which is pervious to air, comprises a fibrous material.

Further according to a preferred embodiment of the present invention, fibrous material 12 comprises natural fibers, for example, wool, linen, cotton, canvas, cannabis, reed, weed, straw, stalks, seaweed, another known natural fiber, and a blend thereof.

According to another preferred embodiment of the present invention, fibrous material 12 comprises fibers derived from cellular materials, for example, Rayon, Viscosa, another known modified cellular fiber, and a blend thereof. Alternatively, material 12 may comprise fibers derived from cellular materials, such as, recycled paper, recycled organic waste, recycled cellular fiber, and mixtures thereof.

According to yet another preferred embodiment of the present invention, fibrous material 12 comprises synthetic polymeric fibers, for example, synthetic polymeric fibers, for example, Polyethylene, Polypropylene, Nylon, Polyester, Kevlar®, Nomex®, Polyacrylonitrile, Polyurethane, another known synthetic polymeric fiber, and a blend thereof.

According to still another preferred embodiment of the present invention, fibrous material 12 comprises polymeric Aramids such as Kevlar®, Nomex®, or blends thereof, so as to produce a fireproof material 12. Alternatively, another known fiber, which is fireproof, may be used. According to yet another preferred embodiment of the present invention, fibrous material 12 comprises a blend of at least two of the aforementioned fibers.

According to still a another preferred embodiment of the present invention, fibrous material 12 comprises fibers, which are fame retardant, or fire and flame retardant.

According to a preferred embodiment of the present invention, fibrous material 12 is knotted, for example, as a rug, with knotted fibers.

According to another preferred embodiment of the present invention, fibrous material 12 is woven, for example, as a woven fabric.

According to yet another preferred embodiment of the present invention, fibrous material 12 is nonwoven.

According to still another preferred embodiment of the present invention, fibrous material 12 comprises fiberglass, for example, glasswool or glass filament.

According to yet another preferred embodiment of the present invention, fibrous material 12 comprises mineral wool, for example, rockwool or slagwool.

According to still another preferred embodiment of the present invention, fibrous material 12 comprises refractory ceramic fibers (RCF).

According to yet another preferred embodiment of the present invention, fibrous material 12 comprises a blend of at least two synthetic wools, selected from fiberglass, mineral wool and RCF.

According to a preferred embodiment of the present invention, material 12 comprises foam.

Additionally, according to a preferred embodiment of the present invention, material 12 comprises an open-cell foam.

Further according to a preferred embodiment of the present invention, foam 12 comprises natural rubber.

According to another preferred embodiment of the present invention, foam 12 comprises chemically modified natural rubber.

According to another preferred embodiment of the present invention, foam 12 comprises synthetic polymeric foam.

Further according to a preferred embodiment of the present invention, foam 12 comprises a foam formed of a polymer selected from polyether, polyester, polyethylene, Polyurethane, urethane, polystyrene, latex, Neoprene, Nylon, and any other known polymer.

Additionally, according to another preferred embodiment of the present inanition, foam 12 comprises an industrial foam, for example, PE foam, EV/VA/EM foam, PPA foam, PU foam, EVA foam, EPS foam, PVC foam, and any other known industrial foam.

According to preferred embodiments of the present invention, foam 12 may be flame retardant. Alternatively, foam 12 may be flame-retardant and flame retardant, to meet FMVSS specifications. For example, foam 12 may comprise expanded polyethylene, expanded polyurethane, or expanded polystyrene, which may be flame retardant or flame-retardant and flame retardant, to meet FMVSS specifications.

According to preferred embodiments of the present invention, foam 12 may have different degrees of flexibility, for example, it may be flexible, or semi rigid foam. Additionally, foam 12, formed of foam, may have a high density of pores, or a low density, and the pore size may be large or small. The foam may have a honeycomb cell structure, or a reticulate cell structure.

According to the present invention, membrane 22 may be attached also to uncoated material 12, such as fibrous material 12 or foam 12, forming channels 28 between membrane 22 and material 12. Preferably, channels 28 are interconnected.

According to a preferred embodiment of the present invention, sound absorbing article 10 is environmentally friendly, so as to cause little health hazard during its manufacturing and installation, produce little or no fumes, during use, and little or no toxic fumes when ignited. Further according to a preferred embodiment of the present invention, sound absorbing article 10 is flame retardant, or fire and is flame retardant, or fireproof.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A sound absorbing article, comprising:
(i) a material which is pervious to air, and which is characterized by proximal and distal surfaces with respect to a sound source, an internal structure, and a specific weight; and
(ii) a coating which adheres to said surfaces and internal structure, thus increasing said specific weight by a predetermined factor.

2. The sound absorbing article of claim 1, wherein said material is a fibrous material.

3. The sound absorbing article of claim 2, wherein said fibrous material is formed of natural fibers.

4. The sound absorbing article of claim 2, wherein said fibrous material is formed of natural fibers, selected from the group consisting of wool, linen, cotton, canvas, cannabis, reed, weed, straw, stalks, seaweed, and a blend thereof.

5. The sound absorbing article of claim 2, wherein said fibrous material is formed of fibers derived from cellular materials.

6. The sound absorbing article of claim 2, wherein said fibrous material is formed of fibers derived from cellular materials selected from the group consisting of Rayon, Viscosa, and a blend thereof.

7. The sound absorbing article of claim 2, wherein said fibrous material is formed of fibers derived from cellular materials, selected from the group consisting of recycled paper, recycled organic waste, recycled cellular fiber, and mixtures thereof.

8. The sound absorbing article of claim 2, wherein said fibrous material is formed of polymeric fibers.

9. The sound absorbing article of claim 2, wherein said fibrous material is formed of polymeric fibers, selected from the group consisting Polyethylene, Polypropylene, Nylon, Polyester, Kevlar®, Nomex®, Polyacrylonitrile, Polyurethane, another known synthetic polymeric fiber, and a blend thereof.

10. The sound absorbing article of claim 2, wherein said fibrous material is formed as a blend of fibers selected from the group consisting of natural fibers, fiber derived from cellular materials, and polymeric fibers.

11. The sound absorbing article of claim 2, wherein said fibrous material is a polyester fiber.

12. The sound absorbing article of claim 2, wherein said fibrous material is fire-proof polymeric fibers.

13. The sound absorbing article of claim 2, wherein said fibrous material is formed of polymeric fibers selected from the group consisting of Nomex®-Kevlar® other Aramids, and a blend thereof.

14. The sound absorbing article of claim 2, wherein said fibrous material is selected from the group consisting of fiberglass, mineral wool, refractory ceramic fibers, and a blend thereof.

15. The sound absorbing article of claim 2, wherein said fibrous material is nonwoven.

16. The sound absorbing article of claim 2, wherein said fibrous material is nonwoven polyester.

17. The sound absorbing article of claim 1, wherein said material is a foam.

18. The sound absorbing article of claim 1, wherein said material is between 10 and 100 mm thick.

19. The sound absorbing article of claim 1, wherein said material is between 2.0 and 10 mm thick.

20. The sound absorbing article of claim 1, wherein said material is between 1.0 and 2.0 mm thick.

21. The sound absorbing article of claim 1, wherein said material is between 0.4 and 1.0 mm thick.

22. The sound absorbing article of claim 1, wherein said coating comprises a natural resin.

23. The sound absorbing article of claim 1, wherein said coating comprises a chemically modified natural resin.

24. The sound absorbing article of claim 1, wherein said coating comprises a synthetic resin.

25. The sound absorbing article of claim 1, wherein said coating comprises a polymeric resin.

26. The sound absorbing article of claim 1, wherein said coating comprises an acrylic resin.

27. The sound absorbing article of claim 1, wherein said coating comprises a flame-retardant acrylic resin.

28. The sound absorbing article of claim 1, wherein said coating comprises a silicate compound.

29. The sound absorbing article of claim 1, wherein said coating comprises a mixture of silicate compounds.

30. The sound absorbing article of claim 1, wherein said coating comprises water glass.

31. The sound absorbing article of claim 1 and further comprising a flame-retardant agent mixed into a liquid adhesive that forms said coating.

32. The sound absorbing article of claim 31, wherein said flame-retardant agent is selected from the group consisting of alumina trihydrate, zinc borate, hexabromocyclododecane, decabromodiphenyl oxide, magnesium hydroxide, ammonium polyphosphates, phosphoric acid, and tetrakis hydroxymethyl phosphonium chloride.

33. The sound absorbing article of claim 31, wherein said flame-retardant agent is water soluble.

34. The sound absorbing article of claim 31, wherein said flame-retardant agent is soluble in a liquid adhesive with which it is mixed, to form said coating.

35. The sound absorbing article of claim 31, wherein said flame-retardant agent forms between 10% and 90% by weight of said coating.

36. The sound absorbing article of claim 31, wherein said flame-retardant agent forms between 30% and 70% by weight of said coating.

37. The sound absorbing article of claim 1, wherein said coating increases said specific weight by a factor between 1.1 and 2.

38. The sound absorbing article of claim 1, wherein said coating increases said specific weight by a factor between 2 and 3.

39. The sound absorbing article of claim 1, wherein said coating increases said specific weight by a factor between 3 and 4.

40. The sound absorbing article of claim 1, wherein said coating increases said specific weight by a factor between 4 and 5.

41. The sound absorbing article of claim 1, wherein said coating increases said specific weight by a factor between 5 and 6.

42. The sound absorbing article of claim 1, wherein said coating increases said specific weight by a factor between 6 and 7.

43. The sound absorbing article of claim 1, wherein said coating increases said specific weight by a factor between 7 and 8.

44. The sound absorbing article of claim 1, wherein said coating increases said specific weight by a factor between 8 and 9.

45. The sound absorbing article of claim 1, wherein said coating increases said specific weight by a factor between 9 and 10.

46. The sound absorbing article of claim 1, wherein said coating increases said specific weight by a factor between 10 and 15.

47. The sound absorbing article of claim 1, wherein said coating increases said specific weight by a factor between 15 and 20.

48. The sound absorbing article of claim 1 and further including a membrane attached to said distal surface.

49. The sound absorbing article of claim 1 and further including a membrane attached to a first surface, selected from the group consisting of said proximal and distal surfaces.

50. The sound absorbing article of claim 49, wherein said membrane is selected from the group consisting of membranes which are impervious and semipervious to airflow.

51. The sound absorbing article of claim 49 wherein said membrane is impervious to airflow.

52. The sound absorbing article of claim 49, wherein said membrane is attached to said first surface only at selected bonding locations, forming channels between said membrane and said first surface.

53. The sound absorbing article of claim 52, wherein said channels are interconnected.

54. The sound absorbing article of claim 52, wherein said selected bonding locations are formed as bonding points, distributed on said first surface.

55. The sound absorbing article of claim 54, wherein said bonding points are evenly distributed on said first surface.

56. The sound absorbing article of claim 55, wherein a distance between two of said bonding points is between 5 and 20 cm.

57. The sound absorbing article of claim 55, wherein a distance between two of said bonding points is between 2 and 5 cm.

58. The sound absorbing article of claim 55, wherein a distance between two of said bonding points is between 1 and 2 cm.

59. The sound absorbing article of claim 55, wherein a distance between two of said bonding points, is between 0.4 and 1 cm.

60. The sound absorbing article of claim 52, wherein said selected bonding locations are formed as bonding lines, distributed on said first surface.

61. The sound absorbing article of claim 60, wherein said bonding lines are evenly distributed on said first surface.

62. The sound absorbing article of claim 52, wherein said selected bonding locations are selected at random.

63. The sound absorbing article of claim 49, wherein said membrane is between 5 and 40μ in thickness.

64. The sound absorbing article of claim 49, wherein said membrane is substantially 20μ in thickness.

65. The sound absorbing article of claim 49 and further including a second membrane attached to a second surface, different from said first surface, selected from the group consisting of said proximal and distal surfaces.

66. The sound absorbing article of claim 65, wherein said second membrane is selected from the group consisting of membranes, which are impervious and semipervious to airflow.

67. The sound absorbing article of claim 65, wherein said second membrane is semipervious to airflow.

68. The sound absorbing article of claim 65, wherein said second membrane is attached to said second surface only at selected bonding locations, forming second channels between said second surface and said membrane.

69. The sound absorbing article of claim 68, wherein said second channels are interconnected.

70. The sound absorbing article of claim 65, wherein said second membrane is between 5 and 40μ in thickness.

71. The sound absorbing article of claim 49, and further including a rigid honeycomb arranged between said first surface and said membrane.

72. The sound absorbing article of claim 71, wherein said rigid honeycomb is formed of kraft paper.

73. The sound absorbing article of claim 72, wherein said kraft paper has a weight between 80 and 220 g/m².

74. The sound absorbing article of claim 71, wherein said rigid honeycomb is formed of a polymer.

75. The sound absorbing article of claim 71, wherein said rigid honeycomb is between 0.5 and 6.0 cm in height.

76. The sound absorbing article of claim 71, wherein said rigid honeycomb has an effective cell size between 0.5 and 3.0 cm.

77. A method of manufacturing a sound absorbing article, comprising:
(i) employing a material, which is pervious to air, and which is characterized by proximal and distal surfaces with respect to a sound source, an internal structure, and a specific weight; and
(ii) coating said material with a film which adheres to said surfaces and internal structure, thus increasing said specific weight by a predetermined factor.

78. The method of claim 77, wherein said coating further includes applying a flame retardant agent.

79. The method of claim 77 and further including attaching a membrane to a first surface selected from the group consisting of said proximal and distal surfaces.

80. The method of claim 79, wherein said membrane is impervious to airflow.

81. The method of claim 79, wherein said attaching further includes attaching only at selected bonding locations, thus forming channels between said membrane and said surface.

82. The method of claim 79, wherein said membrane is formed of polyethylene.

83. The method of claim 79, wherein said membrane is between 5 and 40μ in thickness.

84. The method of claim 79, wherein said membrane is between 15 and 25μ in thickness.

85. The method of claim 79 and further including arranging a rigid honeycomb between said first surface and said membrane.

86. The method of claim 79 and further including attaching a second membrane to a second surface, different from said first surface, selected from the group consisting of said proximal and distal surfaces.

87. The method of claim 86, wherein said attaching further includes attaching only at selected bonding locations, thus forming second channels between said second surface and said membrane.

88. A sound absorbing article, comprising:
(i) a material which is pervious to air, and which is characterized by proximal and distal surfaces with respect to a sound source, an internal structure, and a specific weight; and
(ii) a membrane attached to a first surface, selected from the group consisting of said proximal and distal surfaces, at selected bonding locations, forming channels between said membrane and said first surface.

89. The sound absorbing article of claim 88, wherein said membrane is selected from the group consisting of membranes which are impervious and semipervious to airflow.

90. The sound absorbing article of claim 88, wherein said channels are interconnected.

91. The sound absorbing article of claim 88, wherein said material is a fibrous material.

92. The sound absorbing article of claim 88, wherein said material is a foam.

93. The sound absorbing article of claim 88, wherein said membrane is formed of polyethylene.

94. The sound absorbing article of claim 88, wherein said membrane is between 5 and 40μ in thickness.

95. The sound absorbing article of claim 88, wherein said membrane is substantially 20μ in thickness.

96. The sound absorbing article of claim 88, wherein said selected bonding locations are formed as bonding points, distributed on said first surface.

97. The sound absorbing article of claim 88, wherein said selected bonding locations are formed as bonding lines, distributed on said first surface.

98. The sound absorbing article of claim 88, wherein said selected bonding locations are evenly distributed on said first surface.

99. The sound absorbing article of claim 88, wherein said selected bonding locations are selected at random.
